(19) United States
(12) Patent Application Publication
(10) Pub. No.: US 2017/0306538 A1
(43) Pub. Date: Oct. 26, 2017

(54) NON-WOVEN FABRIC BOARD FOR EXTERIOR OF VEHICLE AND METHOD FOR MANUFACTURING SAME

(71) Applicants: Hyundai Motor Company, Seoul (KR); Kia Motors Corporation, Seoul (KR)

(72) Inventor: Jung Wook Lee, Bucheon (KR)

(21) Appl. No.: 15/294,589

(22) Filed: Oct. 14, 2016

(30) Foreign Application Priority Data
Apr. 26, 2016 (KR) 10-2016-0050585

(51) Int. Cl. D04H 3/018; D04H 3/12; D04H 3/10; D04H 3/007; D04H 3/011; B60R 13/08; G10K 11/162; D01D 5/34

(52) U.S. Cl. CPC D04H 3/018; G10K 11/162; D04H 3/12; D01D 5/34; D04H 3/007; D04H 3/011; B60R 13/0861; D04H 3/102; D10B 2321/021; D10B 2321/022; D10B 2331/04; D10B 2505/12

(57) ABSTRACT

A non-woven fabric board for an exterior of a vehicle and a method for manufacturing same are provided. The non-woven fabric board includes a matrix fiber having a non-circular cross-section and an adhesive fiber having a non-circular cross-section, and the matrix fiber is included in an amount of 50 wt % or greater based on the total weight of the non-woven fiber board. Each of the matrix fiber and the adhesive fiber have a linear density of about 6 to 15 denier and a degree of non-circular shape of about 1.3 to 3.0.

The non-woven fabric board for an exterior of a vehicle has a substantially increased specific surface area by using the non-circular cross-section fibers, improved adhesion efficiency between fibers, and substantially improved mechanical properties. In addition, heat moldability thereof is improved, weight thereof is reduced, and the sound-absorbing performance thereof is substantially improved.

### CROSS-REFERENCE TO RELATED APPLICATION

This application claims under 35 U.S.C. §119(a) the benefit of Korean Patent Application No. 10-2016-0050585 filed on Apr. 26, 2016, the entire contents of which are incorporated herein by reference.

### TECHNICAL FIELD

The present invention relates to a non-woven fabric board for an exterior of a vehicle and a method for manufacturing the same. The a non-woven fabric board may obtain substantially improved rigidity and sound-absorbing properties.

### BACKGROUND

During the driving of a vehicle, external noises are introduced into inside of the vehicle through various routes. In particular, a noise due to the friction between tires and ground, a noise generated by the flow of high-temperature and high-pressure combustion gases released from exhaust systems, a mechanical noise resulting from the operation of engine systems, and the like are introduced into the inside of the vehicle and transmitted to the ears of passengers, and those noises inhibit the comfort and quietness of the vehicle.

For the comfort and quietness of the vehicle, parts such as under covers and wheel guards have been mounted in order to block road noises in the bottom portion of the vehicle while driving and protect the bottom part of vehicle body from the impact of flying debris such as mud and stones. In the related art, the parts typically have been made of a plastic material, such as polypropylene (PP) and glass-fiber reinforcing PP. However, the plastic material causes problems. For example, the plastic material is vulnerable to impact, and has no sound-absorbing properties due to an air-impermeable material.

Recently, heat moldable compressed felt materials have been used in order to secure impact resistance and sound-blocking performance. However, the heat moldable compressed felts have insufficient rigidity, and thus have a limitation to be applied to parts having a large area, such as under covers. In addition, when the felt is compressed in order to improve the rigidity of a non-woven fabric, the sound-absorbing performance efficiency deteriorates.

Meanwhile, parts formed of a compressed non-woven fabric material have been prepared by pre-heating a felt cloth manufactured by a needle punching process in an oven at a predetermined temperature for a predetermined time, and then molding the felt cloth into a part using a cold mold, or pressing the felt cloth at a predetermined temperature for a predetermined time using a hot mold without a separate pre-heating of the felt cloth and molding the felt cloth into a part.

A conventional non-woven fabric cloth is composed of a polyethylene terephthalate (PET) fiber as a matrix fiber and a bicomponent PET fiber as an adhesive fiber for binding between PET fibers, or otherwise, is composed only of a PET fiber. The mechanical properties of a compressed non-woven fabric in the related art have been increased by a system of increasing an areal density (weight per unit area) under a predetermined thickness, or conversely by a system of further reducing the thickness under a predetermined areal density to increase the cohesiveness between fibers.

However, an increase in areal density causes an increase in part weights and material costs, and a reduction in thickness leads to the deterioration in sound absorption rate of the compressed non-woven fabric.

Moreover, in the related art, since a cross-section of the fiber is typically circular, the area of contact between fibers is so small that there is a limitation in improving the cohesiveness, and during the heating for molding, the bulkiness of the cloth fabric is so small that when the treatment is performed under the condition of a predetermined temperature. As such, only the web surface is molten, and thus the intermediate layer part remains fibrous, and as a result, the strength deteriorates.

Accordingly, there is a need for studies on a non-woven fabric board than can be used for an exterior of a vehicle, in which sound-absorbing properties are improved while maintaining rigidity.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention provides a non-woven fabric board for an exterior of a vehicle, in which rigidity is improved and sound-absorbing properties are improved.

In one aspect, the present invention provides a non-woven fabric board for an exterior of a vehicle. The non-woven fabric board may include: a matrix fiber having a non-circular cross-section and an adhesive fiber having non-circular cross-section. The matrix fiber may be included in an amount of about 50 wt % or greater based on the total weight of the non-woven fabric board. The matrix fiber and the adhesive fiber may have a linear density of about 6 to 15 denier and a degree of the non-circular shape of about 1.3 to 3.0.

The term “matrix fiber” as referred to herein includes a fiber constituting the non-woven or woven fabric as a main component. For instance, the matrix fiber constitutes the fiber in an amount greater than about 25 wt %, 30 wt %, 40 wt %, 50 wt %, 60 wt %, 70 wt %, 80 wt % or 90 wt %. A preferred matrix fiber may constitute the non-woven fabric in the present invention in an amount of about 50 wt % or greater.

The term “adhesive fiber” as referred to herein includes a fiber for binding between matrix fibers or other fibers. Preferred adhesive fiber may include a bicomponent fiber. A preferred bicomponent fiber as referred to herein may include two different polymers and is formed by a single spinneret with both the polymers, such that both the polymers can be contained in a same filament. In addition, a preferred adhesive fiber may have a sheath/core structure formed when manufactured using the bicomponent fibers, such that one polymer component (core) is surrounded, at least in part, by the other polymer component (sheath).

The degree of the non-circular shape (α) may be determined by the following Equation 1:

$$Degree of non \text{-} circular shape ( α ) = \frac{ρ}{\sqrt{4 π A}} , \qquad [ Equation 1 ]$$

where a fiber cross-section circumference length is presented as P and a fiber cross-section area is presented as A.

Preferably, a cross-section shape of the matrix fiber and a cross-section shape of the adhesive fiber may be selected from the group consisting of an eight-leaf type, a W type, a hollow type, a flat type, a cross type, a triangle type, and a star type.

The matrix fiber suitably may be selected from the group consisting of polyethyleneterephthalate, polypropylene, Nylon, acryl, viscose rayon, and aramid fiber.

The adhesive fiber suitably may comprise one or more selected from the group consisting of a low-melting point polyethylene terephthalate fiber, a polypropylene fiber, and polyethylene. Preferably, the adhesive fabric may have a sheath/core structure.

In one preferred aspect, a material for the adhesive fiber may have a lower melting point than a material for the typical matrix fiber, such that the adhesive fiber may melt and function as a glue or adhesive material between the matrix fibers during hot molding or heat bonding process whereas the matrix fiber material maintains its original shape or form. For example, the adhesive fiber or adhesive fiber material may have a melting point of about 30° C., of about 40° C., of about 50° C., of about 60° C., of about 70° C., of about 80° C., of about 90° C., of about 100° C., of 150° C., or of about 200° C. less than a melting point of the matrix fiber or matrix fiber material.

Preferably, the fiber cross-section circumference length P of the matrix fiber or the adhesive fiber may be in a range of about 140 to 180 μm, and the fiber cross-section area A of the matrix fiber or the adhesive fiber may be in a range of about 280 to 1,500 μm².

Further provided is an undercover material for an exterior of a vehicle which may comprise the non-woven fabric board as described herein.

In another aspect, the present invention provides a method for manufacturing a non-woven fabric board for an exterior of a vehicle. The method may include molding a fiber aggregate including a matrix fiber having a non-circular cross section and an adhesive fiber having a non-circular cross section into the non-woven fabric board. The matrix fiber may be included in an amount of about 50 wt % or greater based on the total weight of the non-woven fabric board, and the matrix fiber or the adhesive fiber may have a linear density of 6 to 15 denier. In addition, the matrix fiber or the adhesive fiber may have a degree of non-circular shape (α), as defined by the Equation 1, of 1.3 to 3.0.

Preferably, the non-woven fabric board may be molded by a needle punching process or a heat bonding process,

Preferably, a cross-section shape of the matrix fiber and a cross-section of the adhesive fiber may be selected from the group consisting of an eight-leaf type, a W type, a hollow type, a flat type, a cross type, a triangle type, and a star type.

The matrix fiber suitably may be selected from the group consisting of polyethyleneterephthalate, polypropylene, Nylon, acryl, viscose rayon, and aramid fiber.

The adhesive fiber suitably may include one or more selected from the group consisting of a low-melting point polyethylene terephthalate fiber, a polypropylene fiber, and polyethylene, and may have a sheath/core structure.

Preferably, from the Equation 1, fiber cross-section circumference length (P) of the matrix fiber or the adhesive fiber may be in a range of about 140 to 180 μm and a fiber cross-section area (A) of the matrix fiber or the adhesive fiber may be in a range of about 280 to 1,500 μm².

[

Further provided is a vehicle that may comprise the non-woven fabric board as described herein. Preferably, the non-woven board may be installed at an exterior of the vehicle.

The non-woven fabric board for an exterior of a vehicle according to the present invention may have a large specific surface area by using a non-circular cross-section yarn, so as to improve the adhesion efficiency between fibers, and may have substantially improved mechanical properties. In addition, because heat is transmitted well during heating due to large bulkiness and specific area of the fiber, heat moldability may be improved.

The non-woven fabric board may reduce weight thereof by reducing the areal density of the non-woven fabric due to the improved rigidity, and the sound-absorbing performance may be substantially improved.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 illustrates exemplary eight-leaf type, W type, hollow type, flat type, and star type cross-section shapes of an exemplary matrix fiber and an adhesive fiber according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Since the present invention may be modified in various forms and include various exemplary embodiments, specific exemplary embodiments will be illustrated in the drawings and described in detail in the Detailed Description. However, the description is not intended to limit the present invention to the specific exemplary embodiments, and it is to be understood that all the changes, equivalents, and substitutions belonging to the spirit and technical scope of the present invention are included in the present invention. When it is determined that the detailed description of the publicly known art related in describing the present invention may obscure the gist of the present invention, the detailed description thereof will be omitted.

The present invention provides a non-woven fabric board for an exterior of a vehicle. The non-woven fabric board may include a matrix fiber having a non-circular cross section and an adhesive fiber having a non-circular cross section. The matrix fiber may be included in an amount of 50 wt % or greater based on the total weight of the non-woven fiber board. The non-circular cross-section matrix fiber or the non-circular cross-section adhesive fiber may have a linear density of about 6 to 15 denier and a degree of non-circular shape (α) of about 1.3 to 3.0. The degree of non-circular shape (α) may be determined by a following Equation 1. [Equation 1]

$$Degree of non \text{-} circular shape ( α ) = \frac{ρ}{\sqrt{4 π A}}$$

In the Equation 1, a fiber cross-section circumference length is presented as P, a fiber cross-section area is presented as A.

Hereinafter, the non-woven fabric boards for an exterior of a vehicle according to specific exemplary embodiments of the present invention will be described in more detail.

In the related art, there is a problem in that, since a cross-section of the fiber is circular, the area of contact between fibers is not sufficient to improve cohesiveness. In addition, for the circular fabric, during the heating for molding, the bulkiness of the cloth fabric is so small that when the treatment is performed under the condition of a predetermined temperature, only the web surface is molten, and thus the intermediate layer part remains fibrous, and as a result, the strength deteriorates.

Thus, the present inventors have confirmed through experiments that when non-circular cross-section fibers having a predetermined linear density range and a predetermined range of the degree of non-circular shape are used as a matrix fiber and an adhesion fiber used in a non-woven fabric board, due to large bulkiness and specific surface area of the fiber, heat may be transmitted well during heating thereby improving heat moldability and mechanical properties, reducing weight by reducing the areal density of the non-woven fabric due to the improved rigidity, and improving the sound-absorbing performance may be improved.

In one aspect of the present invention, provided is a non-woven fabric board for an exterior of a vehicle. The non-woven fabric board may include a non-circular cross-section matrix fiber and a non-circular cross-section adhesive fiber. The non-circular cross-section matrix fiber may be included in an amount of 50 wt % or greater based on the total weight of the non-woven fiber board.

In particular, the non-circular cross-section matrix fiber or the non-circular cross-section adhesive fiber may have a linear density of about 6 to 15 denier and a degree of non-circular shape of about 1.3 to 3.0.

In one preferred aspect, the non-circular cross-section fiber may have a surface area that may be about 2 to 5 times greater than a conventional circular cross-section fiber.

Generally, when a sound wave has friction against a specific material, viscous loss is generated, thereby causing a result that while the mechanical energy of the sound wave is converted into heat energy, the noise is finally reduced. Based on the physical phenomenon as described above, the non-circular cross-section fiber used in the present invention may form a cross-section structure having an irregular or regular shape unlike a general circular cross-section fiber, and thus may provide advantages. For example, the surface of the fiber where the viscous loss of the sound wave is generated can be maximized, thereby improving the sound-absorbing performance.

The conventional PET fiber has a circular cross-section, so that the cohesiveness between fibers is achieved by point contacts, but the non-circular cross-section fiber has greater specific surface area, so that adhesion efficiency between fibers may be improved to improve mechanical properties. Further, due to large bulkiness and specific area of the fiber, heat may be well transmitted during heating, and thus heat moldability may be improved, thereby improving mechanical properties.

In the non-woven fabric board of the present invention in which non-circular cross-section fibers are used, by a surface having the large area as described above, the noise, vibration, and harshness performance (NVH) which is equivalent to or more than the level of the sound-absorbing material in the related art is expressed even though the surface density becomes lower than that of the sound-absorbing material in the related art, thereby achieving lightweight of the vehicle, and there is an advantage in that much higher sound-absorbing performance is provided even though the non-woven fabric board of the present invention is compared to a general circular cross-section fiber sound absorbing material having the same areal density.

Most of the cross-section of the general synthetic fibers is circular. However, in preferred aspects of the present invention, fibers may be formed to have a non-circular cross-section fiber, for example, the spinneret may be manufactured into a desired shape such as an eight-leaf type, a W type, a hollow type, a flat type, a cross type, a triangle type, and a star type. As such, the cross-section shape of a spun thread has a specific shape other than a circular shape, which can be the same as the shape of the spinneret. Since the non-circular cross-section fiber has greater surface area than that of the conventional circular cross-section fiber, the surface of an object may be maximized and the viscous loss of the sound wave, which is one of the most important factors in the sound properties, may be generated on the surface thereof, thereby providing an effect of improving the sound-absorbing performance.

The specific shape of the non-circular cross-section may not be particularly limited, but preferably, may be an eight-leaf type, a W type, a hollow type, a flat type, a cross type, a triangle type, and a star type, preferably a W type and an eight-leaf type, and may be selected in consideration of required mechanical properties and sound-absorbing performance.

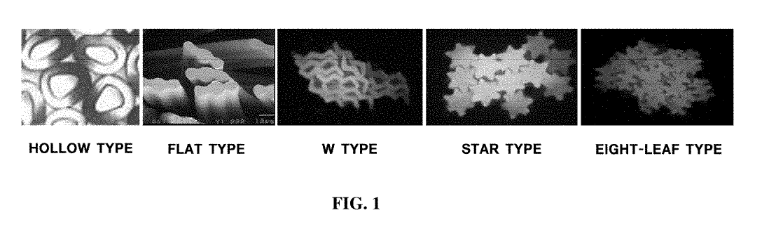

FIG. 1 illustrates exemplary eight-leaf type, W type, hollow type, flat type, and star type cross-section shapes of an exemplary non-circular cross-section matrix fiber and an exemplary non-circular cross-section adhesive fiber.

The non-circular cross-section matrix fiber may be obtained from melt spinning, and the non-circular cross-section matrix fiber can be selected from the group consisting of polyethyleneterephthalate, polypropylene, Nylon, acryl, viscose rayon, and aramid fiber, and polyethyleneterephthalate. Nylon may be suitably used for mass productivity and heat stability.

The adhesion fiber may be a fiber that can be used for adhesion between the non-circular cross-section matrix fibers. The adhesive fiber suitably may include a low-melting point polyethylene terephthalate fiber, a polypropylene fiber, and the like. The non-circular cross-section adhesive fiber may include one or more selected from the group consisting of a low-melting point polyethylene terephthalate fiber, a polypropylene fiber, and polyethylene. In particular, the non-circular cross-section adhesive fiber may have a sheath/core structure. For example, the low-melting point polyethylene terephthalate may include a sheath part and a core part, which are conjugate-spun as the sheath-core structure. The sheath part may include any one selected from the group consisting of amorphousness and a crystal form having a melting temperature of about 180° C. or less. and the core part may include a crystal form having a melting temperature of about 250° C. or greater. In particular, the core part may be molten during the molding of a part, and thus may serve to maintain the shape of the non-woven fabric board by interconnecting fibers.

In the present invention, when the content of the non-circular cross-section matrix fiber is less than about 50 wt %, the mechanical properties may deteriorate, such that the non-circular cross-section matrix fiber suitably may be included in an amount of about 50 wt % or greater based on the total weight of the non-woven fabric board.

Meanwhile, the non-circular cross-section fiber and the non-circular cross-section adhesive fiber suitably may have a linear density of preferably 6 to 15 denier. When the linear density is less than about 6 denier, the tensile moduli of the individual fibers may be decreased, so that the rigidity of the final non-woven fabric may be reduced. When the linear density is greater than about 15 denier, the number of individual fibers in the non-woven fabric having the same areal density may be decreased, so that the mechanical properties of the non-woven fabric may deteriorate.

The non-circular cross-section fiber and the non-circular cross-section adhesive fiber suitably may have a degree of non-circular shape of about 1.3 to 3.0. When the degree of non-circular shape is less than about 1.3, the effect of increasing the surface area compared to the circular shape may not be sufficient, so that the mechanical properties may not be sufficiently improved. When the degree of non-circular shape is greater than about 3.0, the number of crimps may be decreased, so that the point of contact between fibers may deteriorate, so that the mechanical properties may deteriorate.

The degree of non-circular shape (α) may be represented by the following Equation 1, and suitably may have a fiber cross-section circumference length (P) of about 140 to 180 μm and a fiber cross-section area (A) of about 280 to 1,500 μm².

$$Degree of non \text{-} circular shape ( α ) = \frac{ρ}{\sqrt{4 π A}} \qquad [ Equation 1 ]$$

Thus, when the fibers has a 8-leaf type cross-section], the 8-leaf type cross-section fiber suitably may have the degree of non-circular shape (α) in the range of about 1.3 to 3.0, the range of the cross-section circumference length (P) of about 140 to 180 μm and the range of the cross-section area (A) of about 280 to 1,500 μm². When the fiber cross-section circumference length (P) is less than about 140 μm, the specific surface area of the fiber may be decreased, and thus the effect of improving the sound-absorbing performance may not be sufficient, and shrinkage may substantially occur during the heat molding due to the decrease in thickness of the fiber. When the fiber cross-section circumference length (P) is greater than about 180 μm, the linear density of the fiber may be increased, which may indicate that the number of individual fibers in the non-woven fabric having a specific areal density may be decreased. In addition, the sound-absorbing performance may not be sufficiently improved, the gaps between fibers may became excessive, and thus, the rigidity may deteriorate after the heat molding. Preferably, the 8-leaf type cross-section fiber may have the fiber cross-section circumference length P within the above described range.

When the fiber cross-section area (A) is less than about 280 μm², a spinneret having an 8-leaf type cross-section shape for manufacturing processes may not be manufactured, and the 8-leaf type cross-section structure of the actual fiber after the spinneret is spun may not be sufficiently implemented. When the fiber cross-section area (A) is greater than about 1,500 μm², the economic efficiency may be reduced due to the increase in fiber denier and the decrease in spinning rate. In addition, gaps between fibers in the felt may be substantially increased such that the shrinkage may substantially occur and the rigidity may deteriorate during the heat molding. Preferably, the 8-leaf type cross-section fiber may have the fiber cross-section area A within the above described range.

In another aspect of the present invention, provided is a method for manufacturing the non-woven fabric board for an exterior of a vehicle. The method may include molding a fiber aggregate including a matrix fiber having a non-circular cross-section and an adhesive fiber having a non-circular cross-section into a form of a non-woven fabric. The matrix fiber may be included in an amount of about 50 wt % or greater based on the total weight of the non-woven fabric, and the matrix fiber or the adhesive fiber may have a linear density of 6 to 15 denier and a degree of non-circular shape (α) of 1.3 to 3.0.

Preferably, the non-woven fabric may be molded by a needle punching process or a heat bonding process.

The process of manufacturing the non-woven fabric board of the present invention may be the same as the conventional process of molding a non-woven board part, or different from the conventional molding process. The non-woven fabric board may be molded as a part by preheating a needle punched cloth fabric in an oven and using a cold mold, or may be directly molded by using a hot mold.

Hereinafter, the preferred Examples of the present invention will be described in detail with reference to the accompanying drawings. However, these Examples are provided only for exemplifying the present invention, and it is not to be interpreted that the scope of the present invention is limited by these Examples.

### EXAMPLES

The following examples illustrate the invention and are not intended to limit the same.

### Example 1

A PET fiber as a non-circular cross-section matrix fiber and a non-circular cross-section adhesive fiber including a low-melting point PET fiber were used at a weight ratio of 6:4, and a conventional process of producing a heat adhesion non-woven fabric was used to manufacture a non-woven fabric board. The non-woven fabric board was formed to have a thickness of 2 mm and an areal density of 1,200 g/m².

As the non-circular cross-section matrix fiber and the non-circular cross-section adhesive fiber as described above, a fiber having a W-shaped cross-section manufactured through a melt spinning using a W-shaped spinneret was used, and a fiber having a number of crimps of 9.8 ea/inch, a degree of non-circular shape of 2.6, and a linear density of 7 denier was used.

### Example 2

A PET fiber as a non-circular cross-section matrix fiber and a non-circular cross-section adhesive fiber including a low-melting point PET fiber were used at a weight ratio of 6:4, and a conventional process of producing a heat adhesion non-woven fabric was used to manufacture a non-woven fabric board. The non-woven fabric board was formed to have a thickness of 2 mm and an areal density of 1,200 g/m².

As the non-circular cross-section matrix fiber and the non-circular cross-section adhesive fiber as described above, a fiber having a W-shaped cross-section manufactured through a melt spinning using a W-shaped spinneret was used, and a fiber having a number of crimps of 9.8 ea/inch and a degree of non-circular shape of 2.6 was used, and as the non-circular cross-section matrix fiber, a fiber having a linear density of 14 denier was used, and as the non-circular cross-section adhesive fiber, a fiber having a linear density of 7 denier was used.

### Example 3

A PET fiber as a non-circular cross-section matrix fiber and a non-circular cross-section adhesive fiber including a low-melting point PET fiber were used at a weight ratio of 6:4, and a conventional process of producing a heat adhesion non-woven fabric was used to manufacture a non-woven fabric board. The non-woven fabric board was formed to have a thickness of 2 mm and an areal density of 1,200 g/m².

As the non-circular cross-section matrix fiber and the non-circular cross-section adhesive fiber as described above, a fiber having a W-shaped cross-section manufactured through a melt spinning using a W-shaped spinneret was used, and a fiber having a number of crimps of 9.8 ea/inch and a degree of non-circular shape of 2.0 was used, and as the non-circular cross-section matrix fiber, a fiber having a linear density of 14 denier was used, and as the non-circular cross-section adhesive fiber, a fiber having a linear density of 7 denier was used.

### Example 4

A PET fiber as a non-circular cross-section matrix fiber and a non-circular cross-section adhesive fiber including a low-melting point PET fiber were used at a weight ratio of 6:4, and a conventional process of producing a heat adhesion non-woven fabric was used to manufacture a non-woven fabric board. The non-woven fabric board was formed to have a thickness of 2 mm and an areal density of 1,200 g/m².

As the non-circular cross-section matrix fiber and the non-circular cross-section adhesive fiber as described above, a fiber having a W-shaped cross-section manufactured through a melt spinning using a W-shaped spinneret was used, and a fiber having a number of crimps of 9.8 ea/inch and a degree of non-circular shape of 2.0 was used, and as the non-circular cross-section matrix fiber, a fiber having a linear density of 14 denier was used, and as the non-circular cross-section adhesive fiber, a fiber having a linear density of 14 denier was used.

### Comparative Example 1

A circular PET fiber was used to manufacture a non-woven fabric board having a thickness of 2 mm and an areal density of 1,200 g/m² by using a conventional process of producing a heat adhesion non-woven fabric.

### Comparative Example 2

A circular PET fiber and a circular cross-section adhesive fiber including a low-melting point PET fiber were used at a weight ratio of 6:4, and a conventional process of producing a heat adhesion non-woven fabric was used to manufacture a non-woven fabric board. The non-woven fabric board was formed to have a thickness of 2 mm and an areal density of 1,200 g/m². The fiber has a number of crimps of 9.8 ea/inch, and as the circular PET fiber, a fiber having a linear density of 7 denier was used, and as the circular cross-section adhesive fiber, a fiber having a linear density of 4 denier was used.

### Comparative Example 3

A W type PET fiber was used to manufacture a non-woven fabric board having a thickness of 2 mm and an areal density of 1,200 g/m² by using a conventional process of producing a heat adhesion non-woven fabric.

As the W type PET fiber as described above, a fiber having a number of crimps of 6.8 ea/inch, a degree of non-circular shape of 3.5, and a linear density of 7 denier was used.

### Comparative Example 4

A W type PET fiber was used to manufacture a non-woven fabric board having a thickness of 2 mm and an areal density of 1,200 g/m² by using a conventional process of producing a heat adhesion non-woven fabric.

As the W type PET fiber as described above, a fiber having a number of crimps of 10.3 ea/inch, a degree of non-circular shape of 1.2, and a linear density of 7 denier was used.

### Comparative Example 5

A W type PET fiber was used to manufacture a non-woven fabric board having a thickness of 2 mm and an areal density of 1,200 g/m² by using a conventional process of producing a heat adhesion non-woven fabric.

As the W type PET fiber as described above, a fiber having a number of crimps of 9.8 ea/inch, a degree of non-circular shape of 2.6, and a linear density of 4 denier was used.

### Comparative Example 6

A W type PET fiber was used to manufacture a non-woven fabric board having a thickness of 2 mm and an areal density of 1,200 g/m² by using a conventional process of producing a heat adhesion non-woven fabric.

As the W type PET fiber as described above, a fiber having a number of crimps of 9.8 ea/inch, a degree of non-circular shape of 2.6, and a linear density of 15 denier was used.

### Comparative Example 7

A W type PET fiber and a circular cross-section adhesive fiber including a low-melting point PET fiber were used so at a weight ratio of 6:4, and a conventional process of producing a heat adhesion non-woven fabric was used to manufacture a non-woven fabric board. The non-woven fabric board was formed to have a thickness of 2 mm and an areal density of 1,200 g/m².

As the W type PET fiber as described above, a fiber having a number of crimps of 9.8 ea/inch, a degree of non-circular shape of 2.6, and a linear density of 7 denier was used.

### Experimental Example

A flexural modulus evaluated in accordance with the ISO 178 Method A, a tensile strength evaluated in accordance with the ISO 527-4 Type 2, a sound absorption rate evaluated in accordance with the ISO 354, and the impact strength evaluated in accordance with the ISO6603-2 are shown in the following Table 1.

Examples 1 to 4 according to exemplary embodiments of the present invention obtained substantially increased mechanical properties such as flexural modulus, tensile strength, and impact strength, and the average sound absorption rate was also excellent as compared to Comparative Examples.

The non-woven fabric board for an exterior of a vehicle according to the present invention had a large specific surface area by using a non-circular cross-section yarn, so that the adhesion efficiency between fibers was improved, and had large bulkiness and fiber specific area, so that mechanical properties were substantially improved. in addition, because heat was sufficiently transmitted during heating, heat moldability may be improved. Further, weight thereof may be reduced by reducing the areal density of the non-woven fabric due to the improved rigidity, and the sound-absorbing performance may be substantially improved.

TABLE 1

| | Flexural | Tensile | Average sound | Impact |
|---|---|---|---|---|
| | modulus | strength | absorption | strength |
| | (MPa) | (MPa) | rate | (J) |
| Example 1 | 1450 | 51 | 0.44 | 7.3 |
| Example 2 | 1200 | 55 | 0.42 | 6.8 |
| Example 3 | 1150 | 51 | 0.40 | 6.9 |
| Example 4 | 1190 | 55 | 0.39 | 7.0 |
| Comparative | 935 | 25 | 0.32 | 4.5 |
| Example 1 | | | | |
| Comparative | 890 | 31 | 0.35 | 5.6 |
| Example 2 | | | | |
| Comparative | 1050 | 35 | 0.43 | 6.3 |
| Example 3 | | | | |
| Comparative | 1010 | 26 | 0.40 | 4.8 |
| Example 4 | | | | |
| Comparative | 732 | 29 | 0.44 | 5.2 |
| Example 5 | | | | |
| Comparative | 998 | 33 | 0.33 | 5.2 |
| Example 6 | | | | |
| Comparative | 986 | 28 | 0.41 | 6.1 |
| Example 7 | | | | |

Although the exemplary embodiments of the present invention are described in detail, it will be obvious to those skilled in the art that such a specific description is just an exemplary embodiment and the scope of the present invention is not limited thereto. Accordingly, the substantial scope of the present invention will be defined by the appended claims and equivalents thereof.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A non-woven fabric board for an exterior of a vehicle, comprising:
a matrix fiber having a non-circular cross section, and
an adhesive fiber having a non-circular cross section,
wherein the matrix fiber is included in an amount of 50 wt % or greater based on the total weight of the non-woven fabric, and
each the matrix fiber and the adhesive fiber has a linear density of about 6 to 15 denier and a degree of non-circular shape (α) of about 1.3 to 3.0,
wherein the degree of non-circular shape (α) is represented by the following Equation 1,
$$Degree of non \text{-} circular shape ( α ) = \frac{ρ}{\sqrt{4 π A}} , \qquad [ Equation 1 ]$$
wherein P is a fiber cross-section circumference length, and A is a fiber cross-section area.

2. The non-woven fabric board of claim 1, wherein a cross-section shape of the matrix fiber and a cross-section shape of the adhesive fiber are selected from the group consisting of an eight-leaf type, a W type, a hollow type, a flat type, a cross type, a triangle type, and a star type.

3. The non-woven fabric board of claim 1, wherein the matrix fiber is selected from the group consisting of polyethyleneterephthalate, polypropylene, Nylon, acryl, viscose rayon, and aramid fiber.

4. The non-woven fabric board of claim 1, wherein the adhesive fiber comprises one or more selected from the group consisting of a low-melting point polyethylene terephthalate fiber, a polypropylene fiber, and polyethylene.

5. The non-woven fabric board of claim 1, wherein the adhesive fabric has a sheath/core structure.

6. The non-woven fabric of claim 1,
wherein the fiber cross-section circumference length P of the matrix fiber or the adhesive fiber is in a range of about 140 to 180 μm, and the fiber cross-section area A of the matrix fiber or the adhesive fiber is in a range of about 280 to 1,500 μm².

7. An undercover material for an exterior of a vehicle, comprising a non-woven fabric board of claim 1.

8. A method for manufacturing a non-woven fabric board for an exterior of a vehicle, the method comprising:
molding a fiber aggregate comprising a matrix fiber having a non-circular cross section and an adhesive fiber having a non-circular cross into a the non-woven fabric board, wherein the matrix fiber is included in an amount of about 50 wt % or greater based on the total weight of the noon-woven fabric board, and
the matrix fiber or the adhesive fiber has a linear density of about 6 to 15 denier and a degree of non-circular shape (α) of about 1.3 to 3.0,
wherein the degree of non-circular shape (α) is represented by the following Equation 1,
$$Degree of non \text{-} circular shape ( α ) = \frac{ρ}{\sqrt{4 π A}} , \qquad [ Equation 1 ]$$
wherein P is a fiber cross-section circumference length, and A is a fiber cross-section area.

9. The method of claim 8, wherein the non-woven fabric is molded by a needle punching process or a heat bonding process.

10. The method of claim 8, wherein a cross-section shape of the matrix fiber and the adhesive fiber is selected from the group consisting of an eight-leaf type, a W type, a hollow type, a cross type, a triangle type, and a star type.

11. The method of claim 8, wherein the matrix fiber is selected from the group consisting of polyethyleneterephthalate, polypropylene, Nylon, acryl, viscose rayon, and aramid fiber.

12. The method of claim 8, wherein the adhesive fiber comprises one or more selected from the group consisting of a low-melting point polyethylene terephthalate fiber, a polypropylene fiber, and polyethylene.

13. The method of claim 8, wherein the adhesive fiber has a sheath/core structure.

14. The method of claim 8, wherein the fiber cross-section circumference length P of the matrix fiber or the adhesive fiber is in a range of about 140 to 180 μm, and the fiber cross-section area A of the matrix fiber or the adhesive fiber is in a range of about 280 to 1,500 μm².

15. A vehicle comprising a non-woven fabric board of claim 1.

16. The vehicle of claim 15, wherein the non-woven board is an undercover material of the vehicle.
